(19) United States
(12) Patent Application Publication
(10) Pub. No.: US 2004/0125759 A1
(43) Pub. Date: Jul. 1, 2004

(54) Method and mobile station for operating in accordance with a discontinuous transmission mode

(76) Inventors: Donald M. Yochem, Buffalo Grove, IL (US); David P. Kovac, Vernon Hills, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/330,459

(22) Filed: Dec. 27, 2002

(51) Int. Cl. H04L 12/56

(52) U.S. Cl. 370/311; 370/229

(57) ABSTRACT

A method (1100) and a mobile station (160) for operating in accordance with a discontinuous transmission mode are described herein. The mobile station (160) may include a first time constant generator (340), a second time constant generator (350), and a logic unit (330). The first time constant generator (340) may generate a first time constant in response to a first command from the logic unit (330) whereas the second time constant generator (350) may generate a second time constant in response to a second command from the logic unit (330). The first time constant is greater than the second time constant, which in turn, is associated with the discontinuous transmission mode.

### TECHNICAL FIELD

The present disclosure relates to wireless communication systems, and more particularly, to a method and a mobile station for operating in accordance with a discontinuous transmission mode.

### BACKGROUND

During a voice call, an individual may not speak for a period time. In fact, a person speaks less than half of the time during a normal conversation. However, most mobile stations such as cellular telephones are continuously transmitting over the air during the voice call. Typically, the output power of a radio frequency (RF) transmitter within mobile stations is maintained at a desired power level by a conventional automatic output power control circuitry such as the circuitry shown and described in U.S. Pat. No. 5,193,223, and U.S. Pat. No. 5,287,555. In particular, the circuitry shown in U.S. Pat. No. 5,193,223 is responsive to level control signals and a transmit signal from a signal source for maintaining the magnitude of an output signal at one of a plurality of power levels selected by the level control signals. Further, the circuitry shown in U.S. Pat. No. 5,287,555 is responsive to a transmit signal, level control signals, a timing signal defining a series of transmit time intervals, and a supply voltage from a signal source for maintaining the average magnitude of an output signal at a power level selected from a plurality of power levels by the level control signals during the transmit time intervals.

To conserve battery power and to reduce interference, mobile stations may operate in a discontinuous transmission (DTX) mode. In particular, mobile stations may switch off the transmitter within the mobile stations when no speech or data is sent so that the transmitter is not continuously transmitting during the voice call. In current time division multiple access (TDMA) systems, for example, mobile stations may turn on the transmitter for one-third (⅓) of the 20 millisecond (msec) frame or 6.67 msec (i.e., the transmitter is off for 13.33 msec). When operating in the DTX mode, the transmitter will transmit a burst of about 1.4 msec to reduce power consumption.

One aspect of designing a wireless communication system is to optimize resources available to a mobile station. In particular, the mobile station may transmit shorter bursts to conserve even more power and to further reduce interference as described above. However, the conventional automatic output power control circuitry is inadequate to operate in the DTX mode. That is, hardware within current mobile stations is too slow to operate correctly with shorter transmission bursts so that the output power of the mobile station may be provided for a desired duration of time.

Therefore, a need exists to accommodate a shorter transmission burst so that the mobile station may operate in accordance with a discontinuous transmission mode. Further, a need exists to maintain output power of the mobile station at a constant level regardless of either a full transmission burst or a short transmission burst by the mobile station.

### BRIEF DESCRIPTION OF THE DRAWINGS

This disclosure will describe several embodiments to illustrate its broad teachings. Reference is also made to the attached drawings.

FIG. 1 is a block diagram representation of a wireless communication system.

FIG. 2 is a block diagram representation of a mobile station.

FIG. 3 is a block diagram representation of a transmitting unit.

FIG. 4 is a circuit diagram representation of time constant generators.

FIG. 5 is a timing diagram representation of the time constant generators in FIG. 4.

FIG. 6 is a circuit diagram representation of time constant generators.

FIG. 7 is a timing diagram representation of the time constant generators in FIG. 6.

FIG. 8 is another block diagram representation of a transmitting unit.

FIG. 9 is a circuit diagram representation of a switching element.

FIG. 10 is a timing diagram representation of the switching element in FIG. 9.

FIG. 11 is a flow diagram illustrating a method for operating in accordance with a discontinuous transmission mode.

### DETAILED DESCRIPTION

A method and a mobile station for operating in accordance with a discontinuous transmission mode are described. The mobile station generally includes a controller and a transmitting unit. In particular, the transmitting unit may include a first time constant generator, a second time constant generator, and a logic unit. The first time constant generator may be configured to provide a first time constant associated with a first transmission burst. The second time constant generator may be configured to provide a second time constant associated with a second transmission burst. The second time constant is shorter relative to the first time constant such that the second transmission burst is shorter relative to the first transmission burst when the mobile station is operating in the discontinuous transmission mode.

For example, the first time constant generator may include a first capacitor and a first transistor serially coupled to the first capacitor, and the second time constant generator may include a second capacitor and a second transistor serially coupled to the second capacitor. The second capacitor may be smaller in value than the first capacitor so that the second time constant generator may provide a shorter time constant than the first time constant generator. In another example, the first capacitor is serially coupled to the second capacitor, which in turn is serially coupled to the second transistor. Here, the first transistor is operatively coupled to the second capacitor in parallel to short the second capacitor in response to a command from the logic unit.

Alternatively, the transmitting unit may include a switching element and a capacitor. The switching element is operatively coupled to the logic unit described above and the capacitor. The switching element may include a first transistor serially coupled to a first resistor, and a second transistor serially coupled to a second resistor. The logic unit may be configured to activate the switching element to charge the capacitor to provide a time constant for transmission bursts.

A communication system in accordance with the present disclosure is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-55 Time Division Multiple Access (TDMA) digital cellular system, the IS-95 Code Division Multiple Access (CDMA) digital cellular system, the CDMA 2000 system, the Wideband CDMA (WCDMA) system, the Personal Communications System (PCS), the Third Generation (3G) system, the Universal Mobile Telecommunications System (UMTS) and variations and evolutions of these protocols.

A wireless communication system is a complex network of systems and elements. Typical systems and elements include (1) a radio link to mobile stations (e.g., a cellular telephone or a subscriber equipment used to access the wireless communication system), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a switching system, typically including a mobile switching center (MSC), to perform call processing within the system, and (5) a link to the land line, i.e., the public switch telephone network (PSTN) or the integrated services digital network (ISDN).

A base station subsystem (BSS) or a radio access network (RAN), which typically includes one or more base station controllers and a plurality of base stations, provides all of the radio-related functions. The base station controller provides all the control functions and physical links between the switching system and the base stations. The base station controller is also a high-capacity switch that provides functions such as handover, cell configuration, and control of radio frequency (RF) power levels in the base stations.

The base station handles the radio interface to the mobile station. The base station includes the radio equipment (transceivers, antennas, amplifiers, etc.) needed to service each communication cell in the system. A group of base stations is controlled by a base station controller. Thus, the base station controller operates in conjunction with the base station as part of the base station subsystem to provide the mobile station with real-time voice, data, and multimedia services (e.g., a call).

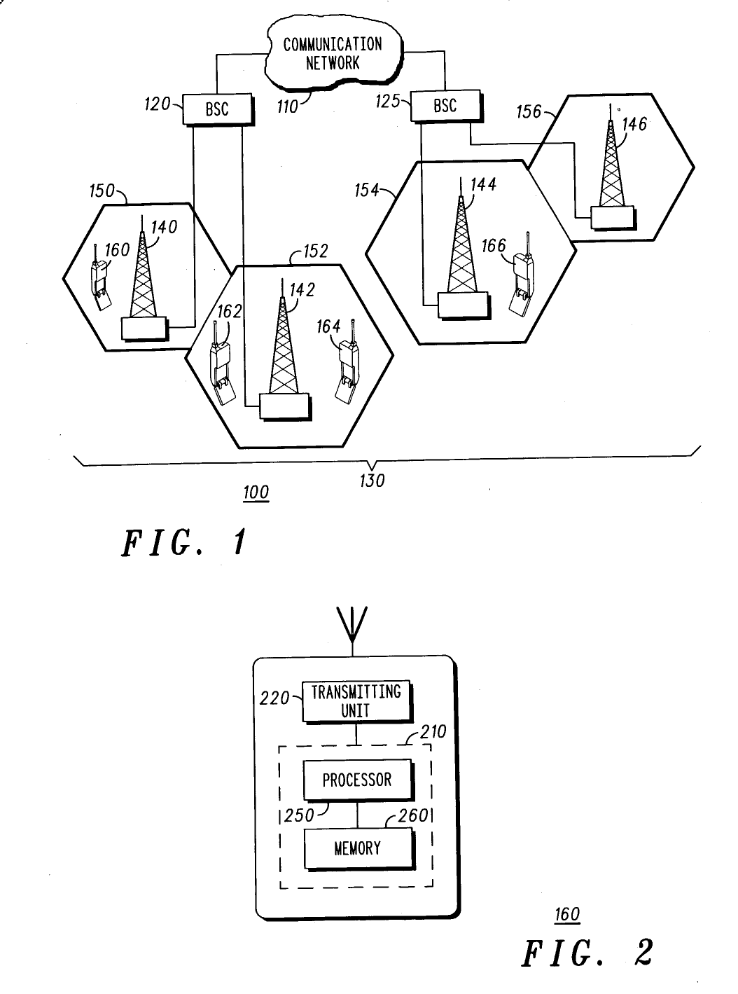

Referring to FIG. 1, a wireless communication system 100 includes a communication network 110, and a plurality of base station controllers (BSC), generally shown as 120 and 125, servicing a total service area 130. As is known for such systems, each BSC 120 and 125 has associated therewith a plurality of base stations (BS), generally shown as 140, 142, 144, and 146, servicing communication cells, generally shown as 150, 152, 154, and 156, within the total service area 130. The BSCs 120 and 125, and base stations 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Ill.

Referring to FIG. 2, a mobile station 160 adapted to operate in accordance with a discontinuous transmission mode is shown. The mobile station 160 generally includes a controller 210, and a transmitting unit 220. The controller 210 includes a processor 250 and a memory 260. The processor 250 is operatively coupled to the memory 260, which stores a program or a set of operating instructions for the processor 250. The processor 250 executes the program or the set of operating instructions such that the mobile station 160 operates as described herein. The program or the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

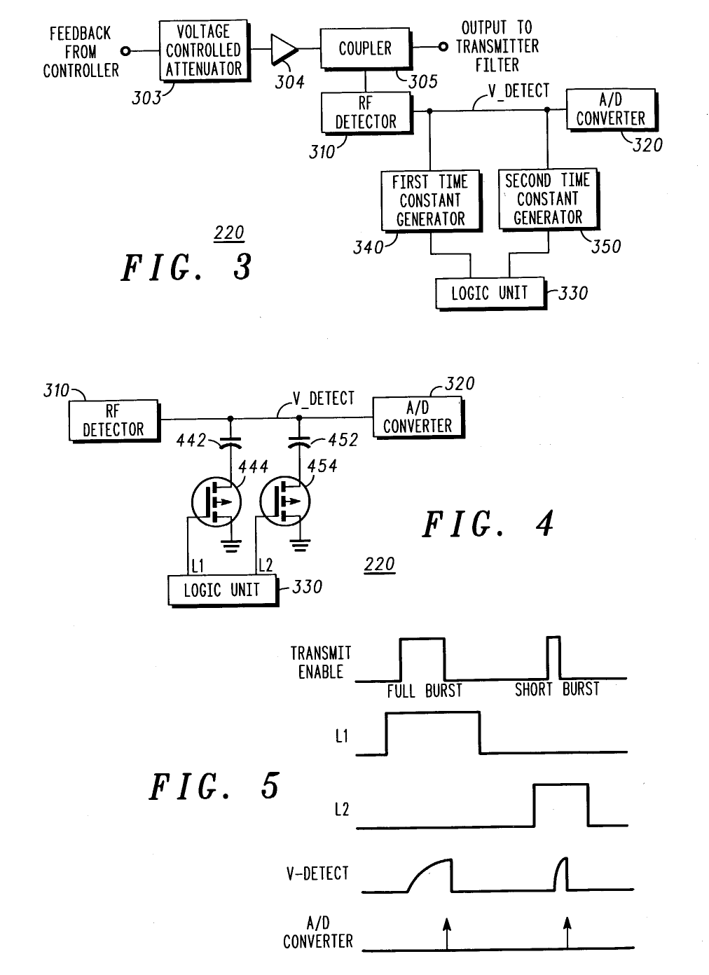

Referring to FIG. 3, the transmitting unit 220 generally includes a voltage control attenuator 303, a power amplifier 304, a coupler such as a radio frequency (RF) coupler 305, a signal detector such as an RF detector 310, a sampling circuit such as an analog-to-digital (A/D) converter 320, a logic circuit 330, and a level control circuit 335. The RF detector 310 is operatively coupled to the voltage attenuator 303, and the power amplifier (PA) 304 via the RF coupler 305. The logic circuit 330 is operatively coupled to the RF detector 310 and the A/D converter 320 via the level control circuit 335, which includes a first time constant generator 340 and a second time constant generator 350. For example, the first time constant generator 340 includes a first capacitor 442 and a first transistor 444, and the second time constant generator 350 includes a second capacitor 452 and a second transistor 454 as shown in FIG. 4. The first capacitor 442 is serially coupled to a drain of the first transistor 444, which in turn, is operatively coupled to the logic circuit 330 (i.e., via a gate of the first transistor 444). The second capacitor 452 is serially coupled to a drain of the second transistor 454, which in turn, is operatively coupled to the logic circuit 330 (i.e., via a gate of the second transistor 454). Accordingly, the first time constant generator 340 and the second time constant generator 350 are operatively coupled to each other in parallel. Based on the capacitance values of the first and second capacitors 442, 452, the first and second time constant generators 340, 350 may provide a first time constant and a second time constant, respectively. For example, the capacitance value of the first capacitor 442 (e.g., 0.022 micro-farads) may be greater than the capacitance value of the second capacitor 452 (e.g., 4700 pico-farads) such that the first time constant is greater than the second time constant as described in further detail below. Further, the first and second capacitor 442, 452 may reduce the amount of ripples in the input into the A/D converter 320, which in turn, lowers the amount of power variation. The first and second transistors 452, 454 may be, but are not limited to, field-effect transistors (FETs) configured to serve as relays from the logic unit (330) to the first and second capacitors 442, 452. Although the method and mobile station disclosed herein are particular well suited to use FETs, persons of ordinary skill in the art will readily appreciate that the teachings herein are in no way limited to such transistors. On the contrary, persons of ordinary skill in the art will readily appreciate that the teachings of this disclosure can be employed with other transistors.

In conjunction with the controller 210 shown in FIG. 2 (via the processor 250), the circuitry of the transmitting unit 220 may operate as an output power control loop of the mobile station 160. That is, the processor 250 may sample the output of the A/D converter 320 to determine an estimate of output power by the mobile station 160. Based on the output of the A/D converter 320, the processor 250 may provide feedback to the RF detector 310 (via the voltage control attenuator 303 and the power amplifier 304) to maintain the output power of the mobile station 160 at a desired power level.

A basic flow for operating in a discontinuous transmission mode that may be applied with the transmitting unit 220 shown in FIG. 4 may start with, for example, the logic unit 330 pulling L1 to a high level to enable the first transistor 444 for a full transmission burst as shown in FIG. 5. As a result, the voltage of the RF detector 310 V_DETECT may be integrated by the first capacitor 442, and the A/D converter 320 may sample the voltage of the RF detector 310 V_DETECT at the end of the full transmission burst.

In contrast for the transmitting unit 220 to provide a short transmission burst, the logic unit 330 may pull L1 to a low level and L2 to a high level. Accordingly, the voltage of the RF detector 310 V_DETECT may be integrated by the second capacitor 452 and sampled by the A/D converter 320. As noted above, the first capacitor 442 may be configured to provide the first time constant whereas the second capacitor 452 may be configured to provide the second time constant. The first time constant may be greater than the second time constant such that the second time constant may be configured to accommodate the shorter transmission burst in a discontinuous transmission (DTX) mode of the transmitting unit 220. Although the output power of the mobile station 160 remains constant, the mobile station 160 may still conserve output power during the DTX mode because of the shorter transmission burst.

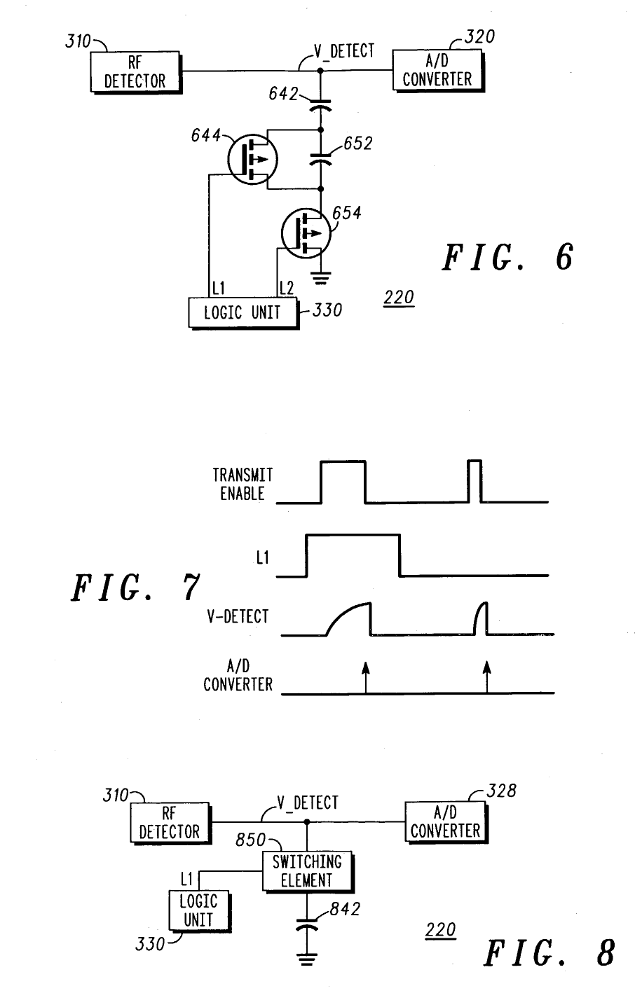

In another example, two capacitors may be serially coupled to each other with a transistor operatively coupled to one of the capacitors in parallel. Referring to FIG. 6, a first capacitor 642 may be serially coupled to a second capacitor 652. The first and second capacitors 642, 652 may be configured to reduce the amount of ripples in the input into the A/D converter 320, which in turn, lowers the amount of power variation. Further, a first transistor 644 may be operatively coupled the second capacitor 652 in parallel, and a second transistor 654 may be serially coupled to the second capacitor 652. The logic unit 330 may be operatively coupled to a gate of each of the first and second transistors 644, 654.

Referring to FIG. 7, the logic circuit 330 may pull L1 to a high level for a full transmission burst. Accordingly, the second capacitor 652 may be shorted by the first transistor 644. As a result, the full transmission burst is based on the first time constant provided by the first capacitor 642. In contrast, L1 may be pulled low for a short transmission burst so that the first transistor 644 is open. Thus, the series combination of the first capacitor 642 and the second capacitor 644 may provide a shorter time constant than the first capacitor 642 by itself.

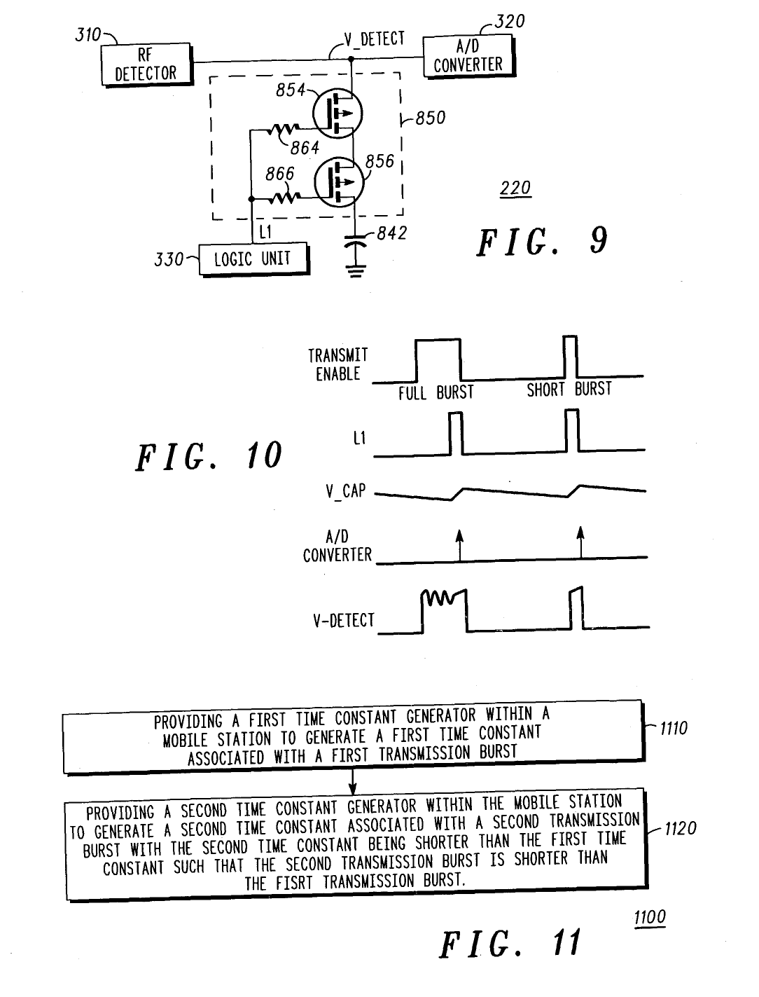

Alternatively, the transmitting unit 220 may include an integrating capacitor 842 and a switching element 850 as shown in FIG. 8. The integrating capacitor 842 may be configured to reduce the amount of ripples in the input into the A/D converter 320, which in turn, lowers the amount of power variation. Referring to FIG. 9, for example, the switching element 850 may include a first transistor 854 and a second transistor 856. The first and second transistors 854, 856 may be configured to prevent the integrating capacitor 842 from discharging through the RF detector 310 when the transmitting unit 220 is in between bursts. In particular, a gate of the first transistor 854 may be serially coupled to a first resistor 864, and a gate of the second transistor 856 may be serially coupled to a second resistor 866. The drain of the second transistor 856 may be operatively coupled to the integrating capacitor 842. In conjunction with the first and second resistors 864, 866, the first and second transistors 854, 856 may prevent leakage from the integrating capacitor 842. The controller 210 (shown in FIG. 2), the A/D converter 320, the integrating capacitor 842, and the switching element 850 may operate in conjunction with one another to perform a sample-and-hold function that persons of ordinary skill in the art will readily recognize.

Referring to FIG. 10, the logic unit 330 may pull L1 to a high level, which connects the integrating capacitor 842 to the voltage of the RF detector 310 V_DETECT through the switching element 850 during a transmission burst. For a full transmission burst, the first and second transistors 854, 856 are open at the beginning of the burst, and then L1 closes the switch element 850 to permit charging of the integrating capacitor 842. For a short transmission burst, L1 closes the switching element 850 at the beginning of the burst. The logic unit 330 may pull L1 to a high level for the same amount of time for either a full transmission burst or a short transmission burst. That is, the logic unit 330 does not change the time period of L1 (i.e., the time period of L1 remains constant) based on the type of transmission burst by the mobile station 160. As a result, the output power control loop within the mobile station 160 may be independent of the type of transmission burst.

When the burst ends (i.e., the transmitting unit 220 is off), L1 is pulled low to enable the integrating capacitor 842 to float so that the integrating capacitor 842 does not discharge (i.e., V CAP). That is, the integrating capacitor 842 may be disconnected in an idle mode to avoid being discharged. Initially, the transmitting unit 220 may produce at least one full transmission burst, and L1 may close the switching element 850 to allow the integrating capacitor 842 to charge over the entire full transmission burst. A full transmission burst and charge time may also be needed at a change in power level or a change in transmitting RF channel. The integrating capacitor 842 may recharge in a shorter time. As a result, a long time constant may be used by the transmitting unit 220 regardless of the type of transmission burst by the transmitting unit 220 (i.e., a full transmission burst or a short transmission burst).

One possible implementation of the computer program executed by the mobile station 160 (e.g., via the controller 210) is illustrated in FIG. 11. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 11, persons of ordinary skill in the art will appreciate that these steps can be performed in other temporal sequences. Again, the flow chart 1100 is merely provided as an example of one way to program the mobile station 160 to operate in accordance with a discontinuous transmission mode. The flow chart 1100 begins at step 1110, wherein the mobile station 160 generates a first time constant within a first time constant generator. The first time constant may be associated with a first transmission burst. The first time constant generator may include a first capacitor and a first transistor serially coupled to the first capacitor. At step 1120, the mobile station 160 may generate a second time constant within a second time constant generator. The second time constant may be associated with a second transmission burst. The second time constant generator may include a second capacitor and a second transistor serially coupled to the second capacitor. Because the second time constant may be configured to be shorter than the first time constant, the second transmission burst may be shorter than the first transmission burst so that the mobile station 160 may conserve output power. Accordingly, the mobile station 160 may provide a short time constant to accommodate a shorter transmission burst during operation the discontinuous transmission mode. As a result, the mobile station may be configured to operate in accordance with the discontinuous transmission mode.

Many changes and modifications to the embodiments described herein could be made. The scope of some changes is discussed above. The scope of others will become apparent from the appended claims.

What is claimed is:

1. In a wireless communication system, a method for operating in accordance with a discontinuous transmission mode, the method comprising:
providing a first time constant generator within a mobile station to generate a first time constant, the first time constant being associated with a first transmission burst; and
providing a second time constant generator within the mobile station to generate a second time constant, the second time constant being associated with a second transmission burst,
wherein the second time constant is shorter than the first time constant such that the second transmission burst is shorter than the first transmission burst.

2. The method of claim 1, wherein the step of providing a first time constant generator within a mobile station to generate a first time constant comprises providing a capacitor and a transistor serially coupled to the capacitor.

3. The method of claim 1, wherein the step of providing a second time constant generator within the mobile station to generate a second time constant comprises providing a capacitor and a transistor serially coupled to the capacitor.

4. The method of claim 1, wherein the communication system comprises one of a time division multiple access (TDMA) based communication system and a code division multiple access (CDMA) based communication system.

5. In a wireless communication system, a mobile station for operating in accordance with a discontinuous transmission mode, the mobile station comprising:
a controller having a memory and a processor operatively coupled to the memory;
a signal detector operatively coupled to the controller;
a sampling circuit operatively coupled to the controller and the signal detector;
a level control circuit having a first time constant generator and a second time constant generator, the first time constant generator being operatively coupled to the signal detector and the sampling circuit, the first time constant generator configured to provide a first time constant associated with a first transmission burst, and
the second time constant generator being operatively coupled to the signal detector and the sampling circuit, the second time constant generator configured to provide a second time constant associated with a second transmission burst, wherein the second time constant being shorter than the first time constant such that the second transmission burst is shorter than the first transmission burst; and
a logic unit operatively coupled to the first and second time constant generator, the logic unit being configured to activate the first and second time constant generators.

6. The mobile station of claim 5, wherein the first and second time constant generators are operatively coupled to each other in parallel.

7. The mobile station of claim 5, wherein each of the first and second time constant generators comprise:
a capacitor operatively coupled to the signal detector and the sampling circuit; and
a transistor serially coupled to the capacitor and the logic unit.

8. The mobile station of claim 5, wherein the first time constant generator comprises:
a first capacitor operatively coupled to the signal detector and the sampling circuit; and
a first transistor operatively coupled to the logic unit, and wherein the second time constant generator comprises:
a second capacitor serially coupled to the first capacitor and operatively
coupled to the first transistor in parallel; and
a second transistor serially coupled to the second capacitor and the logic unit.

9. The mobile station of claim 5 is operable in accordance with one of a time division multiple access (TDMA) based communication protocol and a code division multiple access (CDMA) based communication protocol.

10. In a wireless communication system, a mobile station for operating in accordance with a discontinuous transmission mode, the mobile station comprising:
a controller having a memory and a processor operatively coupled to the memory;
a signal detector operatively coupled to the controller;
a sampling circuit operatively coupled to the controller and the signal detector;
a switching element operatively coupled to the signal detector and the sampling circuit;
a capacitor operatively coupled to the switching element, the capacitor being configured to provide a time constant; and
a logic unit operatively coupled to the switching element, the logic unit being configured to activate the switching element to charge the capacitor with the signal detector and to prevent a discharge of energy from the capacitor.

11. The mobile station of claim 10, wherein the switching element comprises:
a first transistor operatively coupled to the signal detector and the sampling circuit;
a first resistor operatively coupled to the first transistor and the logic unit;
a second transistor operatively coupled to the first transistor and the capacitor; and
a second resistor operatively coupled to the second transistor and the logic unit.

12. The mobile station of claim 10, wherein the logic unit is configured to activate the switching element for a time period for either a full transmission burst or a short transmission burst.

13. The mobile station of claim 10 is operable in accordance with one of a time division multiple access (TDMA) based communication protocol and a code division multiple access (CDMA) based communication protocol.

14. A transmitting unit comprising:
a signal detector;
a sampling circuit operatively coupled to the signal detector;
a switching element operatively coupled to the signal detector and the sampling circuit;
a capacitor operatively coupled to the switching element, the capacitor being configured to provide a time constant; and
a logic unit operatively coupled to the switching element, the logic unit being configured to activate the switching element to charge the capacitor with the signal detector and to prevent a discharge of energy from the capacitor.

15. The mobile station of claim 14, wherein the logic unit is configured to activate the switching element for a time period for either a full transmission burst or a short transmission burst.

16. In a wireless communication system, wherein a logic unit operates in accordance with a computer program embodied on a computer-readable medium for operating in accordance with a discontinuous transmission mode, the computer program comprising:
a first routine that directs the logic unit to activate a first time constant generator within a mobile station to generate a first time constant; and
a second routine that directs the logic unit to activate a second time constant generator within the mobile station to generate a second time constant,
wherein the first time constant being greater than the second time constant, and wherein the second time constant being associated with the discontinuous transmission mode.

17. The computer program of claim 16, wherein the first routine comprises a routine that directs the logic unit to activate a capacitor and a transistor serially coupled to the capacitor to generate a first time constant.

18. The computer program of claim 16, wherein the second routine comprises a routine that directs the logic unit to activate a capacitor and a transistor serially coupled to the capacitor to generate a second time constant.

19. The computer program of claim 16 is operable in accordance with one of a time division multiple access (TDMA) based communication protocol and a code division multiple access (CDMA) based communication protocol.

20. The computer program of claim 16, wherein the medium is one of paper, a programmable gate array, application specific integrated circuit, erasable programmable read only memory, read only memory, random access memory, magnetic media, and optical media.
